(19) United States
(12) Patent Application Publication
(10) Pub. No.: US 2023/0282898 A1
(43) Pub. Date: Sep. 7, 2023

(54) METHOD FOR DETERMINING MECHANICAL STRESSES IN A TRACTION ENERGY STORE

(71) Applicant: MAN Truck & Bus SE, München (DE)

(72) Inventor: Sebastian KRATZER, MÜNCHEN (DE)

(21) Appl. No.: 18/015,047

(22) PCT Filed: Jun. 10, 2021
(86) PCT No.: PCT/EP2021/065558

§ 371 Date: Jan. 6, 2023

(30) Foreign Application Priority Data
Jul. 6, 2020 (DE) 10 2020 117 706.2

(51) Int. Cl. H01M 10/48; B60L 3/12; B60L 58/16

(52) U.S. Cl. CPC H01M 10/482; B60L 3/12; B60L 58/16; H01M 10/486; H01M 2220/20; H01M 2200/20

(57) ABSTRACT

The invention relates to a method for determining mechanical stresses (200) in an electrical traction energy store (110) of a motor vehicle (1100). According to one aspect of the device, a device (100) comprises a traction energy store (110) for storing electrical energy having at least one cell module (120), which comprises in each case a housing (122) and a plurality of secondary cells (300) which are arranged in the housing (122) and are electrically conductively connected to a power interface (124) of the cell module (120). The device (100) also comprises at least one determination unit (130) which is designed to determine, on the basis of an internal resistance of the secondary cells (300) in the at least one cell module (120), a mechanical stress (200) in the secondary cells (300) at different times, a first value of the internal resistance corresponding to a first state of the mechanical stress (200) and a second value of the internal resistance, which is greater than the first value of the internal resistance, corresponding to a second state of the mechanical stress (200) which is greater than the mechanical stress (200) in the first state.

The present disclosure relates to a method for determining mechanical stresses in an electrical traction energy store of a motor vehicle. In particular, but not limited thereto, a device for determining mechanical stresses in an electrical traction energy store of a motor vehicle and a motor vehicle equipped with such a device are disclosed.

The determination of the aging condition of a lithium-ion battery is conventionally based on the number of charging cycles and the known aging effects of lithium-ion batteries, such as a decrease in capacity and an increase in internal resistance. Here, the term capacity can refer to the charge that can be stored in the cell (for example, in units of A·h) or energy that can be stored in the cell (for example, in units of kW·h). The capacity decreases over time and there is an increase in internal resistance due to secondary reactions that take place during charging, for example in the electrolyte or through crystallization (for example, formation of dendrites) at the negative terminal (the anode during the charging process). These secondary processes can include, for example, stretching processes of the active materials or also the mechanical work of the active materials that occurs in the process.

However, in addition to the aforementioned aging effects of lithium-ion batteries, there is always an irreversible pressure increase in the cells or, depending on the enclosure in a cell housing, an equivalent irreversible expansion of the cells.

This irreversible pressure increase is to some extent absorbed by the cell housing (for example, a prismatic cell, a cylindrical cell, or a pouch cell). However, current cells can build up such high pressures over their lifetime that plastic or bursting deformation of the cell housing can also occur.

To prevent this, it is the object of the present disclosure to determine mechanical stresses in a secondary cell or the swelling of a secondary cell.

One aspect relates to a device for determining mechanical stresses in an electrical traction energy store of a motor vehicle. The device comprises a traction energy store for storing electrical energy having at least one cell module, each cell module comprising a housing and a plurality of secondary cells which are arranged in the housing and are electrically conductively connected to a power interface of the cell module. Further, the device comprises at least one determination unit which is designed to determine, on the basis of an internal resistance of the secondary cells in the at least one cell module, a mechanical stress in the secondary cells at different times. Here, a first value of the internal resistance corresponds to a first state of the mechanical stress. A second value of the internal resistance, which is greater than the first value of the internal resistance, corresponds to a second state of the mechanical stress which is greater than the mechanical stress in the first state.

The mechanical stress can be a pressure, preferably a pressure rise.

The secondary cells electrically conductively connected to the power interface of the cell module can be connected in series or in parallel in the cell module. In the case of a plurality of cell modules, their power interfaces can be connected in series or in parallel in the traction energy store.

In the case of a plurality of cell modules, each cell module can be assigned a different one of the determination units, which determines the mechanical stress in the secondary cells of the particular cell module at different times on the basis of the internal resistance of the secondary cells of the particular cell module.

The internal resistance of the secondary cells can comprise an internal resistance of one or all secondary cells (for example, per cell module). The determined mechanical stress can comprise a mechanical stress in one or all of the secondary cells. Alternatively, the internal resistance of the secondary cells can comprise an internal resistance for each of the secondary cells. The determined mechanical stress can comprise a mechanical stress in each of the secondary cells.

The mechanical stress can comprise a pressure in the secondary cells, preferably a pressure deforming the secondary cells (for example only, or only once) in the second state.

The mechanical stress in the secondary cells can comprise a pressure deforming the secondary cells. For example, the mechanical stress can comprise a pressure cell deforming the housing of the secondary cells, preferably in at least one of the secondary cells. Alternatively or additionally, a compressive force of the secondary cells in the particular cell module resulting from the mechanical stress (for example, the pressure) in the secondary cells can be less than a rupture force of the housing of the particular cell module.

Each of the secondary cells can comprise a separator. A permeability, preferably an ion permeability, of the separator can be dependent on the mechanical stress, preferably the pressure, in the particular secondary cell.

Each of the secondary cells can comprise a negative electrode, a positive electrode, and a separator between the negative electrode and the positive electrode. The internal resistance can be a measure of ion permeability and/or a pressure acting on the separator.

The separator can comprise a film or membrane, or a layering of a plurality of membranes or films. Alternatively or additionally, the separator can comprise unwoven fibers or a nonwoven fabric.

The separator can be semi-permeable (partially permeable) or can have an ion-selective permeability (transmissibility). In particular, the separator can be permeable (transmissible) to Li⁺ ions. The permeability of the separator can be the product of the diffusion coefficient and the partition coefficient of the ions divided by a thickness of the separator. The partition coefficient can be the ratio of a concentration of ions on a first side of the separator to the anode and a concentration of ions on a second side of the separator to the cathode. The thickness of the separator can decrease with increasing pressure in the cell module and/or increasing compressive force on the separator.

The ion permeability of the separator can be smaller in the second state than in the first state.

The determination unit can include a measurement module designed to measure the internal resistance of each secondary cell of the cell module or one of the cell modules, preferably on the basis of a measured stress and a measured current of the particular secondary cell.

Alternatively or additionally, the determination unit can comprise a measurement module designed to measure the internal resistance of the or each cell module, preferably on the basis of a measured electrical voltage and a measured electrical current of the particular cell module.

The measured electrical current and/or the measured electrical voltage can be sampled or measured in a measuring interval. The internal resistance can be calculated on the basis of the measured electrical voltage and the measured electrical current according to an equivalent circuit diagram of the particular cell module.

The determination unit can have a control module in which a relationship between the internal resistance and the mechanical stress is stored, and/or which is designed to determine the mechanical stress by means of the stored relationship on the basis of the internal resistance.

The relationship can be dependent on a temperature in the particular cell module or in the secondary cells, preferably wherein in the first state and/or in the second state of the mechanical stress the internal resistance is a monotonically decreasing function of the temperature. Alternatively or additionally, the relationship can be dependent on a state of charge or an open-circuit voltage of the particular cell module or the secondary cells, preferably wherein in the first and/or in the second state of mechanical stress the internal resistance is a monotonically increasing function of the state of charge or the open-circuit voltage.

Alternatively or additionally, a first or second threshold value for the internal resistance can depend on a temperature and/or a state of charge and/or an open-circuit voltage of the cell module.

The determination unit can be further designed to determine the mechanical stress in the housing of the or each cell module. The mechanical stress in the particular cell module can correspond to the mechanical stress in the secondary cells minus a restraining force of housings of the secondary cells.

The housings of the secondary cells can be arranged adjacently to each other and/or free of play and/or form-fittingly in the particular cell module. The secondary cells can be arranged in the housing of the particular cell module without play. For example, the cells can comprise mutually parallel cylinders and/or can be arranged hexagonally. Alternatively or additionally, the secondary cells in force exchange can be arranged adjacently to one another or can be in force exchange via spacer elements. The spacer elements can comprise cooling channels.

The secondary cells can be densely arranged. The secondary cells can be directly adjacent to each other or (for example, partially) enclosed. The secondary cells can be clamped with a clamping force in the first state, wherein the clamping force is increased in the second state.

The determination unit can further be designed to determine the mechanical stress in the traction energy store. The mechanical stress in the traction energy store can correspond to the mechanical stress in the at least one cell module minus a holding force of the housing of the cell module.

The housings of the cell modules can be arranged in the traction energy store adjacently to one another and/or without play and/or form-fittingly.

The control unit can be designed to control a switching state of the traction energy store or the particular cell module depending on the detected internal resistance, for example to avoid a mechanical overloading of the housing of the particular cell module.

The at least one cell module can comprise at least one contactor in each case, which is designed to interrupt the electrically conductive connection between the secondary cells and the power interface of the particular cell module. The determination unit, preferably the control module, can be designed to control the at least one contactor depending on the determined mechanical stress.

Depending on the determined mechanical stress, a switching state of the contactor can be controlled. The determination unit can open the contactor of the particular cell module depending on the detected internal resistance. In particular, the determination unit can open the contactor of the particular cell module depending on the mechanical stress assigned to the detected internal resistance.

The dependence of the controlled switching state can include a comparison of the detected internal resistance with a predetermined internal resistance. The housing of the cell module can be mechanically loaded by the secondary cells (for example, without play and/or adjacently to one another) due to the pressure in the secondary cells. The predetermined internal resistance can be calculated according to a mechanical load limit of the housing of the cell module and/or the housings of the secondary cells.

The determination unit, preferably the control module, can be designed to disconnect the electrically conductive connection, preferably by means of the contactor, if the determined mechanical stress exceeds a first limit value and/or if an increase of the determined mechanical stress exceeds a second limit value.

The determination unit can be designed to determine the mechanical stress and/or to compare the determined mechanical stress with the first and/or second limit value at least once in each charging cycle of the traction energy store.

The determination unit can be designed to determine the mechanical stress in different charging cycles of the traction energy store at the same state of charge and/or the same temperature of the particular cell module or the secondary cells and/or to compare the determined mechanical stress with the first and/or second limit value.

The determination unit can compare a course of the determined mechanical stress with a stored course. The stored course of the internal resistance can also be referred to as a characteristic curve. The course can be stored as a function of a number of charging cycles or a charge conversion or a power conversion of the traction energy store or the particular cell module.

According to a further aspect, a motor vehicle, in particular a commercial vehicle, is provided. The motor vehicle, for example the power train of the motor vehicle, comprises an electrical traction energy store and a device for determining mechanical stresses in the traction energy store.

Further features and advantages of the present disclosure are described below with reference to the accompanying drawings, in which:

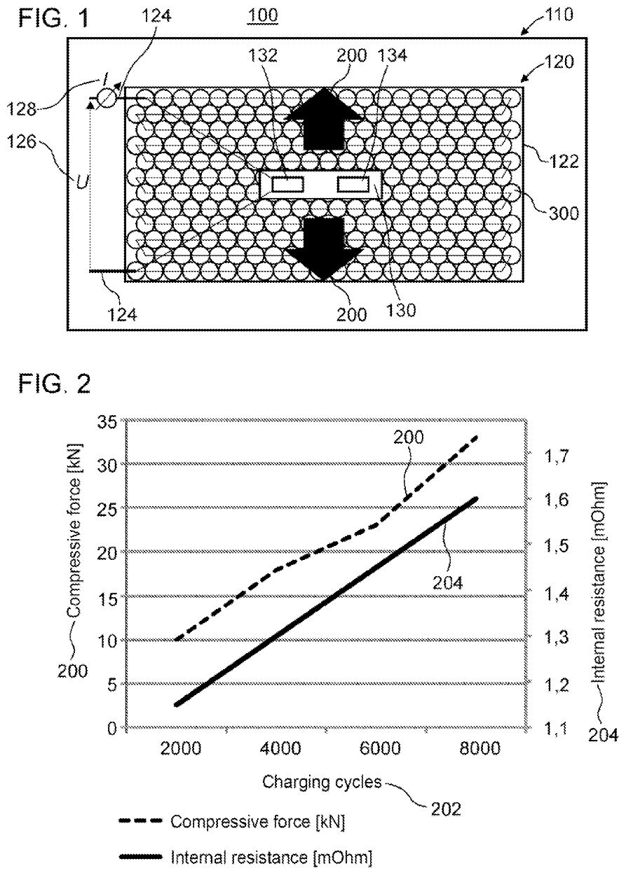

FIG. 1 shows a schematic sectional view of an exemplary embodiment of a device for determining mechanical stresses in the traction energy store;

FIG. 2 shows a schematic diagram of the mechanical stress and of the electrical internal resistance as a function of aging of an exemplary embodiment of the traction energy store, the relationship of which can be stored in each exemplary embodiment of the device;

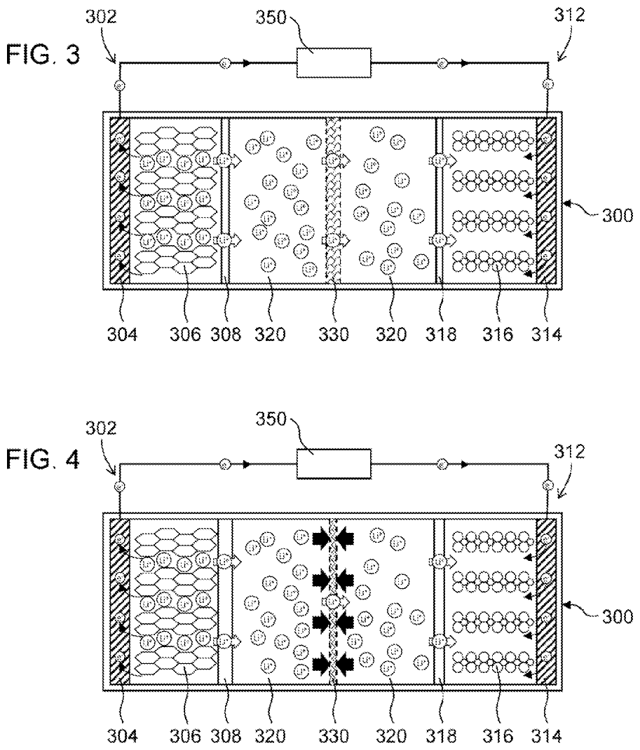

FIG. 3 shows a schematic sectional view of an exemplary embodiment of the secondary cell in the first state, which can be used in any exemplary embodiment of the device;

FIG. 4 shows a schematic sectional view of the exemplary embodiment of the secondary cell in the second state, which can be used in any exemplary embodiment of the device;

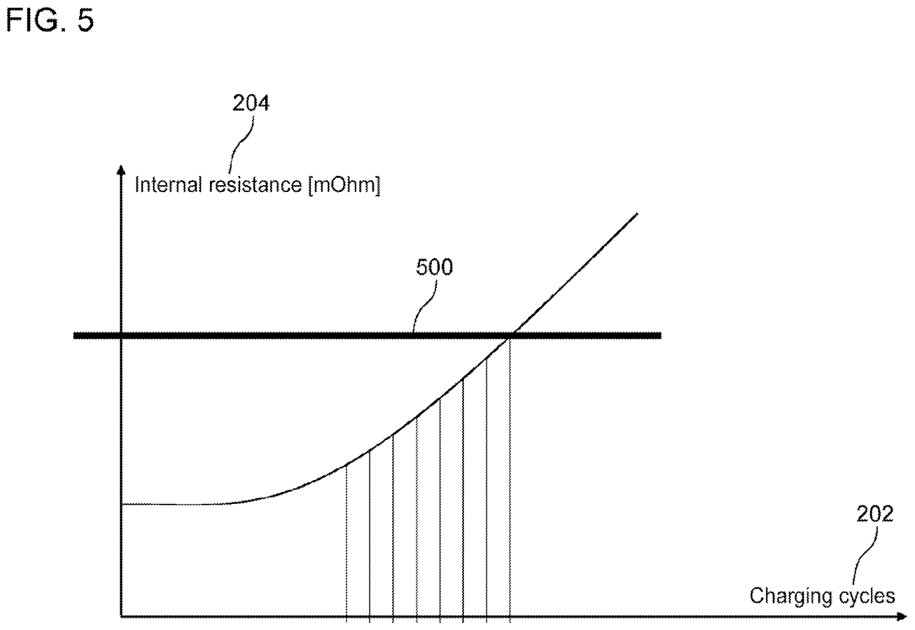

FIG. 5 shows a schematic diagram of the internal resistance as a function of aging of an exemplary embodiment of the traction energy store and a limit value which corresponds to a first limit value of the mechanical stress and can be stored in each exemplary embodiment of the device;

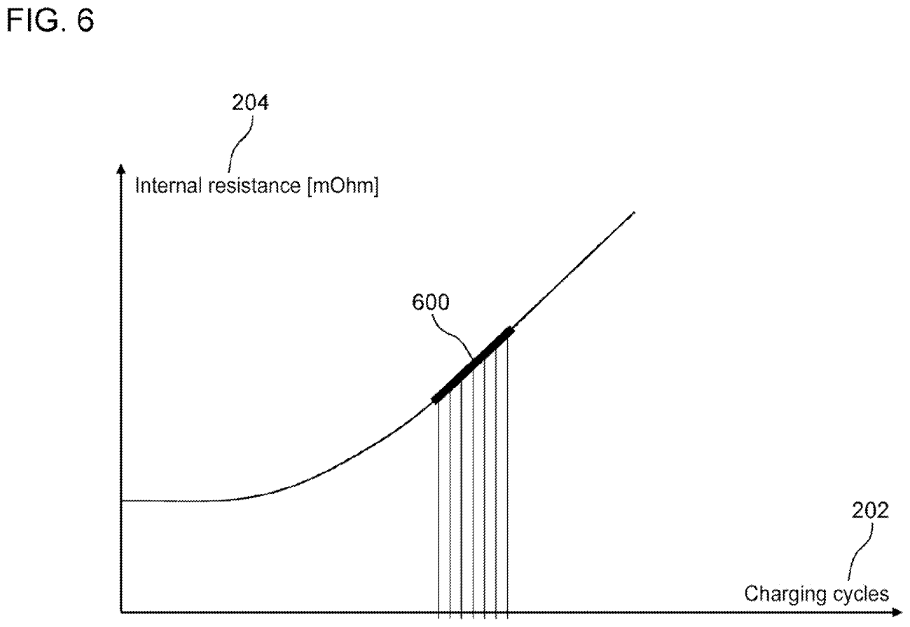

FIG. 6 shows a schematic diagram of the internal resistance as a function of aging of an exemplary embodiment of the traction energy store and a slope which corresponds to a second limit value of the mechanical stress and can be stored in each exemplary embodiment of the device;

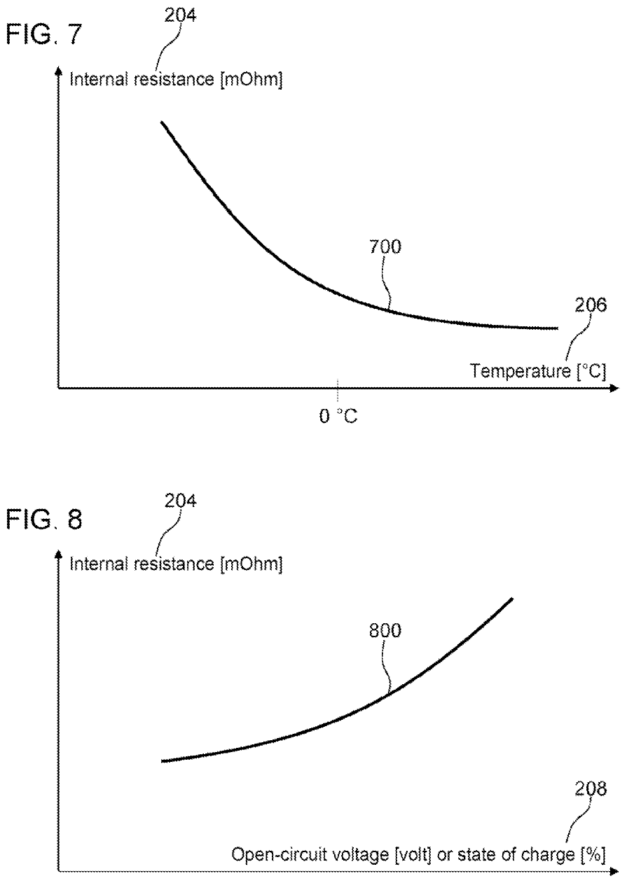

FIG. 7 shows a schematic diagram of an exemplary embodiment of a temperature dependence of the internal resistance, which can be stored in each exemplary embodiment of the device;

FIG. 8 shows a schematic diagram of an exemplary embodiment of a state-of-charge dependence of the internal resistance, which can be stored in each exemplary embodiment of the device;

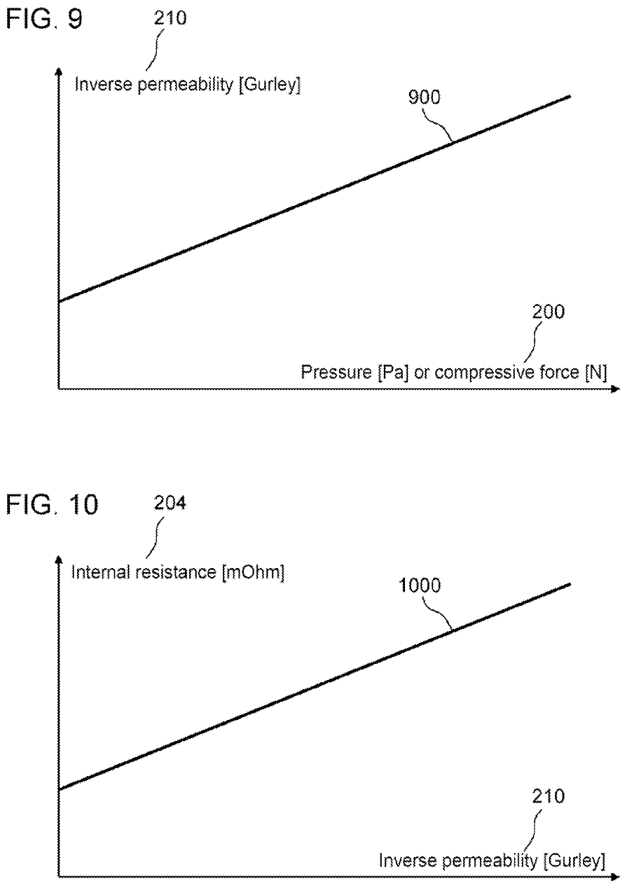

FIG. 9 shows a schematic diagram of the permeability of an exemplary embodiment of the separator depending on the mechanical stress, the relationship of which can be stored in each exemplary embodiment of the device;

FIG. 10 shows a schematic diagram of the internal resistance of an exemplary embodiment of the secondary cell depending on the permeability of the separator, the relationship of which can be stored in each exemplary embodiment of the device; and

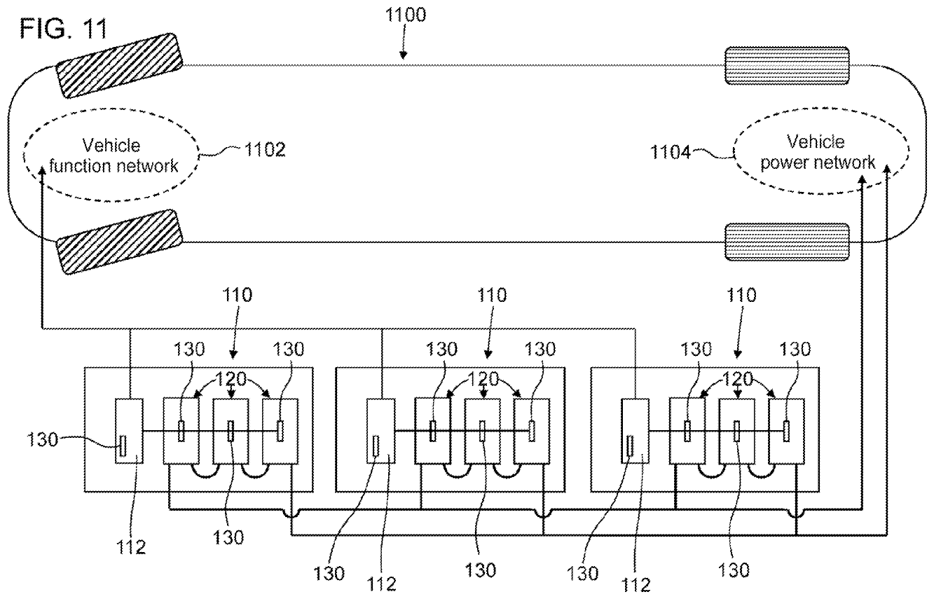

FIG. 11 shows a schematic illustration of an exemplary embodiment of the motor vehicle with an exemplary embodiment of the device.

FIG. 1 shows an exemplary embodiment of a device generally denoted by reference sign 100 for determining mechanical stresses 200 in an electrical traction energy store 110 of a motor vehicle.

The device 100 comprises a traction energy store 110 for storing electrical energy. The traction energy store 110 comprises at least one cell module 120, in each case comprising a housing 122 and a plurality of secondary cells 300 arranged in the housing 122 and electrically conductively connected to a power interface 124 of the cell module 120 and/or of the traction energy store 110.

The device 100 further comprises at least one determination unit 130 designed to determine a mechanical stress 200 in the secondary cells 300 at different times on the basis of an internal resistance of the secondary cells 300 in the at least one cell module 120.

The determination unit 130 can comprise a measurement module 132 that determines the internal resistance on the basis of a voltage 126 and a current 128 at the power interface 124. A relationship between the internal resistance and the mechanical stress 200 is stored in a control module 134 of the determination unit 130. A first value of the internal resistance 204 corresponds to a first state of mechanical stress 200. A second value of the internal resistance 204 greater than the first value of the internal resistance 204 corresponds to a second state of mechanical stress 200 greater than the mechanical stress 200 in the first state.

Determining the mechanical stress 200 can include detecting and/or diagnosing and/or monitoring the mechanical stress 200, preferably an increase in the pressure in the secondary cells or an increase in a swelling of the secondary cells.

FIG. 2 shows a schematic diagram of the mechanical stress 200 and the electrical internal resistance 204 as a function of aging of an exemplary embodiment of the traction energy store 110. A resulting relationship between the mechanical stress 200 and the electrical internal resistance 204 can be storable in each exemplary embodiment of the device 100. For example, as shown in the exemplary embodiment of FIG. 2, there can be a linear relationship between the mechanical stress 200 and the electrical internal resistance 204.

The mechanical stress 200 and the electrical internal resistance 204 can be detected and evaluated as a function of any extent of aging (or useful life) of the traction energy store 110 to determine the relationship, for example by eliminating the extent of aging as a common parameter when determining the relationship between the mechanical stress 200 and the electrical internal resistance 204.

While in FIG. 2 the electrical internal resistance 204 and the mechanical stress 200 (for example, pressure) in the secondary cells 120 are each recorded over the course of the charging cycles 202 as an exemplary aging variable, a first variant of each exemplary embodiment can detect or monitor the mechanical stress 200 as a function of the electrical charge throughput (for example, in Ah) or the energy throughput (for example, in kWh), preferably at the power interface 124. A second variant of each exemplary embodiment can detect or monitor the electrical internal resistance 204 and the mechanical stress 200 as a function of a state of health (SoH) (for example, determined according to the prior art) of the secondary cells 300.

A plurality of secondary cells 300 (cells for short) can be arranged together geometrically or according to a tightest packing (for example, adjacently to one another) in a cell module 120. As a result, a single-cell extent of all cells 300 in a cell module 120 can be accumulated or added up.

By means of a design of a cell housing of each cell 300 or by means of a design of the housing 122 of the cell module 120, the resulting length extent (for example, in one or more dimensions) can be accepted. However, if the customer-specific use of the cells 300 and/or of the cell module 120 is so intensive that the cell housing and/or the housing 122 of the at least one cell module 120 can no longer absorb the forces of the mechanical deformation, mechanical failure (for example, breakage) of the cell housing and/or of the housing 122 may occur. This can result in safety hazards, for example, a short circuit may occur, an open high voltage (HV) may be present, and/or an electrolyte may leak.

There can be instances where the State of Health (SoH) of a cell 300, based on a prior-art aging variable (for example, a capacity degradation) of a cell 300 is still alright. However, the cell 300 may have already generated critically high compressive forces 200. In the prior art, no satisfactory method for detecting and/or diagnosing the mechanical stress 200 exists in this regard.

Exemplary embodiments of the device 100 can, preferably without pressure sensors (for example, in the electrolyte or as strain gauges in the cell housing of the cell 300 or in the housing 122 of the cell module 120), determine the pressure on the basis of the internal resistance 204.

FIG. 3 shows a schematic sectional view of an exemplary embodiment of the secondary cell in the first state, which is generally denoted by the reference sign 300 and can be used multiple times in each exemplary embodiment of the device 100 (in particular in each cell module 120). FIG. 4 shows a schematic sectional view of the exemplary embodiment of the secondary cell 300 in the second state. Further, in each of FIGS. 3 and 4, an electrical load 350 is added by way of example in order to illustrate electronic current flow outside the cell 300 and the ionic current flow inside the cell 300 during discharge of the cell 300.

The cell 300 comprises a negative terminal as a negative electrode 302 and a positive terminal as a positive electrode 312.

The negative terminal 302 has a copper foil as the negative current collector 304. The negative current collector 304 is in electrically conductive contact with a negative active material 306 for lithium intercalation, for example graphite, silicon, or pure lithium.

The positive terminal 312 has an aluminum foil as positive current collector 314. The positive current collector 314 is in electrically conductive contact with a positive active material 316 for lithium ion storage, for example a metal phosphate, a metal oxide, a metal fluoride, a metal sulfide, or nickel-cobalt-manganese.

Between the negative terminal 302 and the positive terminal 312 there is an electrolyte 320, for example anhydrous lithium salts in an organic solvent, and a separator 330.

Separators 330 installed internally in the cell have a pressure-dependent ion permeability. If the pressure 200 in the cell 300 increases sharply, the ion permeability of the separator 330 decreases. This leads to a decrease, for example an abrupt decrease, in the ion permeability, which is detected by an increase in the internal resistance 204 of the cell 300.

The separator can comprise a microporous plastic, such as nonwoven fabrics comprising glass fibers or polyethylene.

FIGS. 3 and 4 each schematically show a secondary cell 300 (cell for short) with lithium as the active material. The negative terminal 302 donates electrons during the discharge shown in FIGS. 3 and 4, thus is the site of oxidation, i.e., the anode. The positive terminal 312 accepts electrons during the discharge shown in FIGS. 3 and 4, thus is the site of reduction, i.e., the cathode. Conversely, when the cell 300 is charged, the negative terminal 302 is the cathode and the positive terminal 312 is the anode of the redox reaction.

Depending on the cell voltage and stability of the electrolyte 320, secondary reactions occur with the electrolyte 320. The mostly solid decomposition products of the secondary reactions accumulate at the interface between the negative electrode 302 and the electrolyte 320 and form the so-called “solid-electrolyte interface” (SEI), i.e., a passive interface 308 that is electronically insulating but permeable to lithium ions.

The passive interface 308 is shown schematically in FIGS. 3 and 4. When the passive interface 308 is formed and remains stable after a few cycles, it helps stabilize the electrochemical system in the cell 300 because the passive interface 308 can prevent further exothermic decomposition of the electrolyte 320, which at worst could lead to thermal burnout of the cell 300.

A passive interface 318 can also be formed at the positive electrode 312 and is technically referred to as a “cathode-electrolyte interphase” (CEI).

As shown schematically in FIG. 4 compared to FIG. 3, the formation of the passive interface 308 and/or the passive interface 318 can displace volume in the closed cell 300 (for example, by crystallization) and thus can be a cause of the increase in mechanical stress 200 (for example, pressure) in the cell 300. For example—in addition to a direct contribution of the passive interfaces 308 and 318 to the internal resistance 204—there is also an indirect contribution to the internal resistance due to the increase in pressure in the cell 300, which in turn reduces the pressure-dependent ion permeability of the separator 330.

Exemplary embodiments of the device 100 can measure the internal resistance 204 of the cell module 120 and/or the individual cells 300 by means of sensors already located in a battery management system (BMS), preferably a measurement module 132 for measuring the current 128 and the voltage 126 of the cell module 120 or an individual cell voltage of the cells 300. For example, under a given load current 128, a voltage drop 126 across the cell module 120 or a voltage drop across the cell 300 can be determined. Alternatively or additionally, the device 100, for example the determination unit 130, can be implemented using a suitably designed BMS.

In a first variant of each exemplary embodiment of the device 100, the relationship between the mechanical stress 200 and the internal resistance 204 is stored in the BMS 130 as a characteristic curve of the internal resistance 204 of the separator 330 versus the pressure 200 (for example, a compressive force). This characteristic curve can be described in terms of any characteristic curve (for example, Gurley depending on the pressure 200) that reflects ion permeability depending on compressive force 200. If an increase in the internal resistance 204 is detected that coincides with the stored characteristic curve, the pressure 200 can be determined. For example, the second state of the pressure 200 can be determined, whereupon the determination unit 130 (for example, the BMS) carries out suitable measures.

In a second variant of each exemplary embodiment of the device 100, which can optionally be combined with the first variant, the currently measured internal resistance 204 is determined in the determination unit 130 (for example, in the BMS). If a certain value as the first limit value (for example, 100 to 200 mOhm) is exceeded, the second state of the pressure 200 can be determined, whereupon the determination unit 130 (for example, the BMS) carries out the measures.

FIG. 5 shows such a first limit value 500 for the internal resistance 204, which according to the relationship corresponds to the first limit value of the mechanical stress 200 and/or the second state of the mechanical stress 200.

FIG. 5 further schematically shows the internal resistance 204 as an exemplary function of an extent of the aging of the traction energy store 110, for example the charging cycles 202. When the first limit value 500 is exceeded, the measures are carried out.

FIG. 6 also shows the internal resistance 204 as a function of the aging of the traction energy store 110, for example the number of charging cycles 202. For example, according to the first variant, a slope 600 of the internal resistance 204 stored as a characteristic curve is detected, which corresponds to a second limit value of the mechanical stress 200 and/or the second state of the mechanical stress 200. The measures are carried out in response to the determination of the second state.

The suitable measures could include shutting down the particular cell 300 and/or shutting down the cell module 120 containing the particular cell 300 and/or shutting down the traction energy store 110. Alternatively or additionally, the suitable measures can comprise a decommissioning of the traction energy store 110.

FIG. 7 shows a schematic diagram of an exemplary embodiment of a temperature dependency 700 of the internal resistance 204, which can be stored in each exemplary embodiment of the device 100. For example (preferably in any state of mechanical stress 200), the measured internal resistance 204 can be corrected according to the temperature dependence 700 before applying the relationship to determine the mechanical stress 200. Alternatively or additionally, the relationship can be corrected according to the temperature dependence 700.

FIG. 8 shows a schematic diagram of an exemplary embodiment of a state of charge dependency 800 of the internal resistance 204, which can be stored in each exemplary embodiment of the device 100. For example, (preferably in any state of mechanical stress 200) the measured internal resistance 204 can be corrected according to the state of charge dependency 800 before applying the relationship to determine the mechanical stress 200.

Alternatively or additionally, the relationship can be corrected according to the state of charge dependency 800. The state of charge 208 can be measured as an open-circuit voltage (OCV) of the particular cell 300 or the particular cell module 120.

FIG. 9 shows a schematic diagram of the permeability 210 (for example, the permeability of lithium ions) of an exemplary embodiment of the separator 330 depending 900 on the mechanical stress 200. For example, the inverse permeability is linear with respect to the pressure 200.

FIG. 10 shows a schematic diagram of the internal resistance 204 of an exemplary embodiment of the cell 300 depending 1000 on the permeability 210 of the separator 330. For example, the inverse permeability is linear to the internal resistance 204.

In each exemplary embodiment of the device 100, the relationship between the internal resistance 204 and the pressure 200 can be determined from the dependencies 900 and 1000 and/or can be stored in the determination unit 130.

The relationship can be valid or applicable (for example, for a plurality of cells 300) for a given morphology of the separator 330.

FIG. 11 shows a schematic illustration of an exemplary embodiment of the motor vehicle 1100 with an exemplary embodiment of the device. For clarity, components of the device 100, in particular the traction energy store 110 and the determination unit 130 are shown outside the motor vehicle. Here, the determination unit 130 can be implemented at one or more or any of the locations denoted by reference sign 130 in FIG. 11.

For example, the determination unit for determining the mechanical stress in individual cells 300 is arranged in the particular cell module 120. Alternatively or additionally, the determination unit 130 for determining the mechanical stress is arranged in the cell module 120 or in individual cell modules 120 in the traction energy store 110, for example in a central battery management system 112. Optionally, the motor vehicle can comprise two or more traction energy stores 110.

The determination unit 130 can exchange data with a vehicle function network 1102 of the motor vehicle 1100 via a data line. The exchanged data can include an interrogation of the mechanical stress 200 by the motor vehicle and a response of the determined mechanical stress 200 by the determination unit 130.

Further, the traction energy store 110 or traction energy stores 110 can be electrically conductively connected to a vehicle power network 1104 (for example, the power train). In the case of an implementation of the determination unit 130 in the central battery management system 112 of the traction energy store 110, the electrically conductive connection between the traction energy store 110 and the vehicle power network 1104 can be interrupted by means of a contactor in response to the determination of the second state of the mechanical stress 200.

Although the present disclosure has been described with reference to exemplary embodiments, it is apparent to a person skilled in the art that various modifications can be made and equivalents can be used as substitutes. Further, many modifications can be made to adapt a particular situation or material to the teachings of the present disclosure. Consequently, the present disclosure is not limited to the disclosed exemplary embodiments, but comprises all exemplary embodiments falling within the scope of the appended claims.

### LIST OF REFERENCE SIGNS

110 traction energy store
112 central battery management system
120 cell module
122 housing of the cell module
124 power interface of the cell module
126 electrical voltage of the cell module
128 electrical current of the cell module
130 determination unit, preferably battery management system (BMS)
132 measurement module of the determination unit
134 control module of the determination unit
200 mechanical stress, preferably force or compressive force
202 cell module charging cycle
204 cell module internal resistance
206 cell module temperature
208 open-circuit voltage (OCV) or state of charge
210 permeability, in particular ion permeability
300 secondary cell in the cell module (cell for short)
302 negative terminal, also: negative electrode
304 negative current collector, also: current arrester, preferably copper foil
306 negative active material for lithium intercalation, preferably graphite, silicon or pure lithium
308 passive interface, also known technically as: solid electrolyte interface (SEI)
312 positive terminal, also: positive electrode
314 positive current collector, also: current arrester, preferably aluminum foil
316 positive active material for lithium ion storage, preferably metal phosphate, metal oxide, metal fluoride, metal sulfide or nickel-cobalt-manganese
318 passive interface, also known technically as: Cathodic Electrolyte Interface (CEI)
320 electrolyte, preferably anhydrous lithium salts in organic solvent
330 separator of the cell
350 electrical load
500 threshold value of the internal resistance
600 increase in internal resistance
700 temperature dependence of the internal resistance
800 state of charge dependence of the internal resistance
900 relationship between permeability and mechanical stress
1000 relationship between internal resistance and permeability
1100 motor vehicle
1102 vehicle function network
1104 vehicle power network

1-15. (canceled)

16. A device for determining mechanical stresses in an electrical traction energy store of a motor vehicle, comprising:
a traction energy store for storing electrical energy having at least one cell module, each cell module comprising a housing and a plurality of secondary cells which are arranged in the housing and are electrically conductively connected to a power interface of the cell module; and
at least one determination unit which is designed to determine, on the basis of an internal resistance of the secondary cells in the at least one cell module, a mechanical stress in the secondary cells at different times, wherein a first value of the internal resistance corresponds to a first state of the mechanical stress and a second value of the internal resistance, which is greater than the first value of the internal resistance, corresponds to a second state of the mechanical stress which is greater than the mechanical stress in the first state.

17. The device as claimed in claim 16, wherein the mechanical stress in the secondary cells comprises a pressure.

18. The device as claimed in claim 17, wherein the pressure deforms the secondary cells in the second state.

19. The device as claimed in claim 16, wherein each of the secondary cells comprises a separator, and wherein a permeability of the separator is dependent on the mechanical stress in the particular secondary cell.

20. The device as claimed in claim 19, wherein:
the permeability comprises an ion permeability, or
the mechanical stress comprises a pressure.

21. The device as claimed in claim 20, wherein the ion permeability of the separator is smaller in the second state than in the first state.

22. The device as claimed in claim 16, wherein the determination unit comprises a measurement module designed to measure the internal resistance of each secondary cell of the cell module or one of the cell modules.

23. The device as claimed in claim 22, wherein the measurement module is designed to measure the internal resistance of each secondary cell of the cell module or one of the cell modules on the basis of a measured stress and a measured current of the particular secondary cell.

24. The device as claimed in claim 16, wherein the determination unit comprises a measurement module designed to measure the internal resistance of the or each cell module.

25. The device as claimed in claim 24, wherein the measurement module is designed to measure the internal resistance of each cell module on the basis of a measured electrical voltage and a measured electrical current of the particular cell module.

26. The device as claimed in claim 16, wherein the determination unit comprises a control module in which a relationship between the internal resistance and the mechanical stress is stored, and which is designed to determine the mechanical stress by means of the stored relationship on the basis of the internal resistance.

27. The device as claimed in claim 26, wherein the relationship is dependent on:
a temperature in the particular cell module or in the secondary cells, or
a state of charge or an open-circuit voltage of the particular cell module or the secondary cells.

28. The device as claimed in claim 27, wherein:
in the first state or in the second state of the mechanical stress the internal resistance is a monotonically decreasing function of the temperature; or
in the first or in the second state of mechanical stress the internal resistance is a monotonically increasing function of the state of charge or the open-circuit voltage.

29. The device as claimed in claim 16, wherein the determination unit is further designed to determine the mechanical stress in the housing of the or each cell module, wherein the mechanical stress in the particular cell module corresponds to the mechanical stress in the secondary cells minus a restraining force of housings of the secondary cells.

30. The device as claimed in claim 16, wherein the determination unit is further designed to determine the mechanical stress in the traction energy store, wherein the mechanical stress in the traction energy store corresponds to the mechanical stress in the at least one cell module minus a holding force of the housing of the cell module.

31. The device as claimed in claim 16, wherein the at least one cell module comprises at least one contactor in each case, which is designed to interrupt the electrically conductive connection between the secondary cells and the power interface of the particular cell module, and
wherein the determination unit is designed to control the at least one contactor depending on the determined mechanical stress

32. The device as claimed in claim 31, wherein the determination unit is designed to disconnect the electrically conductive connection if the determined mechanical stress exceeds a first limit value or if an increase of the determined mechanical stress exceeds a second limit value.

33. The device as claimed in claim 32, wherein:
the determination unit is a control module; or
the electrically conductive connection is the contactor.

34. The device as claimed in claim 32, wherein:
the determination unit is designed to determine the mechanical stress or to compare the determined mechanical stress with the first or second limit value at least once in each charging cycle of the traction energy store; or
the determination unit is designed to determine the mechanical stress in different charging cycles of the traction energy store at the same state of charge, or the same temperature of the particular cell module or the secondary cells, or to compare the determined mechanical stress with the first or second limit value.

35. A motor vehicle comprising a device for determining mechanical stresses in an electrical traction energy store of the motor vehicle as claimed in claim 16.

36. The motor vehicle of claim 35, wherein the motor vehicle is a commercial vehicle.
